(19) United States
(12) Patent Application Publication
(10) Pub. No.: US 2015/0232211 A1
(43) Pub. Date: Aug. 20, 2015

(54) Detachable Clip for Bungee Cords and Methods of Use

(71) Applicants: Robert David Garnache, Shoreline, WA (US); Carla J. Elder, Edmonds, WA (US)

(72) Inventors: Robert David Garnache, Shoreline, WA (US); Carla J. Elder, Edmonds, WA (US)

(21) Appl. No.: 14/612,051

(22) Filed: Feb. 2, 2015

Related U.S. Application Data
(60) Provisional application No. 61/966,148, filed on Feb. 14, 2014.

(51) Int. Cl. B65B 13/02; F16G 11/12

(52) U.S. Cl. CPC B65B 13/02; F16G 11/12

(57) ABSTRACT

A detachable clip for adjustably shortening a bungee cord or linking multiple bungee cords in an elastic mesh, each bungee cord having two hooks and each clip having a generally planar body with two slots for receiving the cord, where each slot has an open end and a blind end and is configured to precisely squeeze the rubbery core of the cord so that it bulges up around the clip and does not slip under a standard range of loads.

### CROSS REFERENCE TO RELATED APPLICATIONS

This application is related to and claims priority under 37 CFR §119(e) to U.S. Provisional Patent No. 61/966,148, entitled “Universal Adjustable Bungee Cord Clip”, filed 14 Feb., 2014, which is herein incorporated in full by reference for all purposes.

### FIELD OF THE INVENTION

The claimed invention relates to the field of attachable fasteners for bungee cords, where the fasteners are configured to increase the range of uses for the cords.

### BACKGROUND

Bungee cords are used worldwide—millions are sold and used each year. They are commonly used to secure objects without tying knots (unlike ropes) and to absorb shock. The two cord diameters most commonly available are 9.5 mm (about three-eighths of an inch) and 12 mm (about a half-inch) diameter cords, where the half-inch cords are generally used for heavier commercial loads and the three-eighth inch cords are used for most personal tasks. For light use, 8 mm and 6 mm cords are also sold. Bungee cords are sold in a few standard lengths and usually have metal or plastic hooks for anchoring the two ends.

Despite the versatility of conventional bungee cords, there is a problem that has plagued all users: namely, the cord is often the wrong length for the task at hand. Because of this, the cord is often either too loose or won't fit, i.e., not short enough or not long enough. This can result in a hazard such as when loads are secured in the back of a vehicle and work their way loose, resulting in material falling from the vehicle. Many people try to solve this problem by tying one or more knots in the cord to shorten it. These knots are almost impossible to undo, so effectively a person has permanently shortened their bungee cord. Next time the cord is used, it may be too short! Optionally, the cords may be cut and knotted together in the right length, again an irreversible change. People muddle through; wrapping the cord haphazardly around the load until it fits. Even so, depending on where the ends are anchored, the tension in the cord may be unsatisfactory. These methods also add complexity to what should be a quick and simple task, and are frustrating and time consuming, and may damage the cord with no guarantee of success.

This “wrong length” problem has been addressed by providing a custom cord having a special feature designed into the cord itself to shorten it, or a custom adjustable hook that can be moved to a desired spot along the cord and then locked in while the free end dangles (such as shown at www.bungeecord.com, accessed 19 Jan. 2015). These cords may be formed as flat straps and have adjustment buckles affixed to the end hooks, but the problem of the loose end(s) remains. Various bungee cords be viewed at www.hookandcord.com (accessed 19 Jan. 2015) and are sold under names such as Highland, KnotBone, CamJam, along with similar kinds variously branded for vehicle and home use. These custom bungees are more expensive, are not detachable to be interchanged with existing cords, and are not nearly as readily available as the generic bungees that are sold at big box retailers, department stores, and hardware stores across the country. What is needed is a specialty fastener to be sold wherever bungee cords are sold that reduces the need for specialized cord combinations and buckles, allowing individual cords to be reconfigured or combined at will according to the task at hand.

Cords are often used one at a time, but use of pairs joined at the center is known to assist in better securing loads. However, pre-fabricated binary or tertiary cord systems are sold as dedicated systems, so that the capacity to make one's own combinations from an assortment of individual bungee cords is simply not possible with the cord systems of the art.

Thus there is a need in the art for a simple, small and inexpensive cord adaptor/fastener that solves these and related problems for bungee cord users. A detachable adaptor clip that provides additional flexibility and functionality to existing bungee cords would be desirable and is an object of this invention.

### SUMMARY

Disclosed is a detachable bungee cord clip (hereinafter may also be referred to as “a clip of the invention”) that is backwards-compatible with most of the millions of bungee cords currently in use and forward-compatible with most bungee cords sold for specialized applications.

The inventive clip solves the problem of making adjustments to and reconfiguring bungee cords according to a needed length and then releasing the bungee cord if another length is needed. Because the clip is an accessory device that attaches to one or more sizes of commonly used bungee cords, it can be stored in a toolbox or a pocket, or may be attached to each cord so that the cords don't tangle during storage. When the clip of the invention is attached to any common or custom-made bungee cord, the cord's length can be shortened and unshortened at will in just seconds. Advantageously, unique configurations may be formed by combining the clip with one or more bungee cords or by using two or more clips in combination.

In a first preferred embodiment, the clip is configured for use with bungee cords having an outside dimension of about ⅜th inch and the slots have an inside width dimension of 7/32± 1/32th inch (5.556±0.794 mm).

In a second preferred embodiment, the clip is configured for use with bungee cords having an outside dimension of about ½ inch and the slots have an inside width dimension of 9/16± 1/32^{th} inch (7.144±0.794 mm). This clip, having slightly wider slots, is used with larger cords, as was determined by trial and error.

Thus different clips may be used for different cords. Because the cords currently available are most commonly either ⅜″ or about ½ inch OD, only two clips will serve for all users having standard bungee cords. A mark on the clip, a color, or annotation may be used to distinguish a compatible bungee cord from an incompatible cord.

The slots are configured to receive each a compatible bungee cord length and the slot inside width dimension is configured to resist slippage of a bungee cord length through the slot from side to side (without resisting slippage of the bungee cord in and out of the slot). As the bungee cord is stretched under load, the core of the cord bundles up against the walls of the slot, strengthening the resistance to slippage of the cord through the slot. Advantageously, the resistance is high with respect to slippage through the slot, but low with respect to slippage in and out along the slot. More surprisingly, by orienting the slots in opposite but parallel directions relative to the ends of the body, any tensioning force is divided into a dominant force that stretches the sheath and core “upstream” and “downstream” from the clip, and a smaller force that effectively slides the cord deeper into the pocket formed at the blind ends of the slots, essentially “self-seating” the cord in a locked position that is only strengthened by further tension on the cord. The clip has a pair of slots, where each slot is configured to receive each a compatible bungee cord length and the slot inside width dimension is configured to resist slippage of a bungee cord length through the slot from side to side without resisting slippage of the bungee cord in and out of the slot.

The invention also is defined by methods of use of the clip of the invention wherein the method may include a step for providing a clip as herein described, and more generally includes methods of making attachments, joints and splices between any two positions or “segments” on a length of a bungee cord and/or a plurality of bungee cords.

When a detachable clip has one receiving slot and a second receiving slot that are transposed in orientation to each other, the body is termed an “S”-shaped body. Other body shapes such as, but not to limited to, an “E”-shape, “Z” shape, or a “C” shape offer comparable but individually distinct benefits. Slightly modifying the body shapes so that the outer legs may extend and wrap part way around the main body of a clip of the invention creates an “entry channel” for the cord, unlike the rings of the prior art that are used to hold captive bundles of cords. Also to be considered are slots that are angled, tapered or curved and of varying lengths.

With experimentation, we found surprisingly that in the “S”-shaped body, where the blind ends of the slots are offset on the plate body, a pulling motion of a bungee cord length in each slot causes a minor pivoting motion of the plate that aids in cooperatively self-seating a bungee cord length in the blind end pockets of the slot. The slots are configured with a radius or bevel at the open end, the radius or bevel to facilitate rapid insertion of a bungee cord into each the slots. Engagement and disengagement of the clips on the cords is quick and simple and involves no damage to the cord. Cords may used without customization of the attached endpieces, typically but not limited to hooklets as known in the art.

The elements, features, steps, and advantages of the invention will be more readily understood upon consideration of the following detailed description of the invention, taken in conjunction with the accompanying drawings, in which presently preferred embodiments of the invention are illustrated by way of example.

It is to be expressly understood, however, that the drawings are for illustration and description only and are not intended as a definition of the limits of the invention. The various elements, features, steps, and combinations thereof that characterize aspects of the invention are pointed out with particularity in the claims annexed to and forming part of this disclosure. The invention does not necessarily reside in any one of these aspects taken alone, but rather in the invention taken as a whole.

### BRIEF DESCRIPTION OF THE DRAWINGS

The teachings of the present invention are more readily understood by considering the drawings, in which:

FIG. 1A is an overall view of an “S”-shaped detachable clip. The “S”-shape body includes three body segments and two receiving slots defined by the body segments. Each receiving slot has an open end and a blind end. FIG. 1B is a view of an “S”-shaped bungee cord clip for a standard half-inch diameter bungee cord.

FIGS. 2A and 2B are views of a clip of the invention and a bungee cord where the clip is used to form a loop in the cord, thereby adjusting the bungee's length.

FIGS. 3A and 3C are views of a length of a bungee cord in section with and without a clip. FIG. 3B-3B and FIG. 3D-3D show cross-sections of the core structure and sheath to demonstrate the before and after appearance of the core material under the pinching action of the clip.

FIG. 4 is a view of an “S”-shaped clip that is “self-seated” under tension on a bungee cord. A loop in the cord member is represented by two cross-sections drawn in the slots of the clip. Force vectors are drawn as arrows.

FIGS. 5A and 5B demonstrate one way in which a detachable clip can be used on a bungee cord.

FIGS. 6A and 6B are views of another way a detachable clip can be used on a bungee cord.

FIG. 7 is a view of a detachable clip securing two ends of a bungee cord.

FIG. 8 is a first view of a bungee cord as bundled for storage.

FIG. 9 is a second view of a bungee cord as bundled for storage in a unique double-loop configuration. Note that the clip slots are dimensioned to capture the cord at four points and the cord is formed into a double loop.

FIG. 10 summarizes how body plan and slot configuration results in more or fewer uses for bungee cords. Seven configurations are tabulated for five body shapes, including “S”, “Z”, “E”, “C” and “O”.

FIG. 11A illustrates a plan view of an “E”-shaped bungee cord clip.

FIG. 11B is a plan view of a “C”-shaped clip.

FIG. 11C is a plan view of a “Z”-shaped clip.

FIG. 11D depicts a clip having arcuate slots in a generally “S”-shaped body.

FIG. 11E depicts a clip having divergent slots in a generally “E”-shaped body.

FIG. 12 is a plot demonstrating relative performance of a clip as a function of slot width.

The drawing figures are not necessarily to scale. Certain features or components herein may be shown in somewhat schematic form and some details of conventional elements may not be shown in the interest of clarity, explanation, and conciseness. The drawing figures are hereby made part of the specification, written description and teachings disclosed herein.

### GLOSSARY

Certain terms are used throughout the following description to refer to particular features, steps or components, and are used as terms of description and not of limitation. As one skilled in the art will appreciate, different persons may refer to the same feature, step or component by different names. Components, steps or features that differ in name but not in structure, function or action are considered equivalent and not distinguishable, and may be substituted herein without departure from the invention. Certain meanings are defined here as intended by the inventors, i.e., they are intrinsic meanings. Other words and phrases used herein take their meaning as consistent with usage as would be apparent to one skilled in the relevant arts. The following definitions supplement those set forth elsewhere in this specification. Unless otherwise defined, all technical and scientific terms used herein have the same meaning as commonly understood by one of ordinary skill in the art to which this invention belongs. In case of conflict, the present specification, including definitions, will control.

A “bungee cord” (sometimes spelled “bungie”) is an elastic cord composed of a rubbery core having a plurality of elastic strands generally surrounded by a woven sheath. The sheath is not elastic but is woven in a spiral braid so that a longitudinal stretch causes it to squeeze the core, resulting in excellent elastic rebound when released, and limiting the ultimate stretchability to below the yield point in the core. Manufacturers generally recommend that the stretch be limited to 50% of the cord's length for safety. These cords have been used since the beginning of 20^{th}century, and may have been initially developed for aircraft undercarriages, for launching gliders, and for parachute harnesses. Modern usage involves securing vehicle loads, strapping suitcases, and the like, worldwide.

An “octopus” is a term that refers to a product having more than one bungee cord secured by an enclosing ring in the middle and thus having four or more hooked ends. The ring is generally not positionable and the lengths of the cords are not adjustable. Also, the cords cannot be disengaged from the ring for individual use.

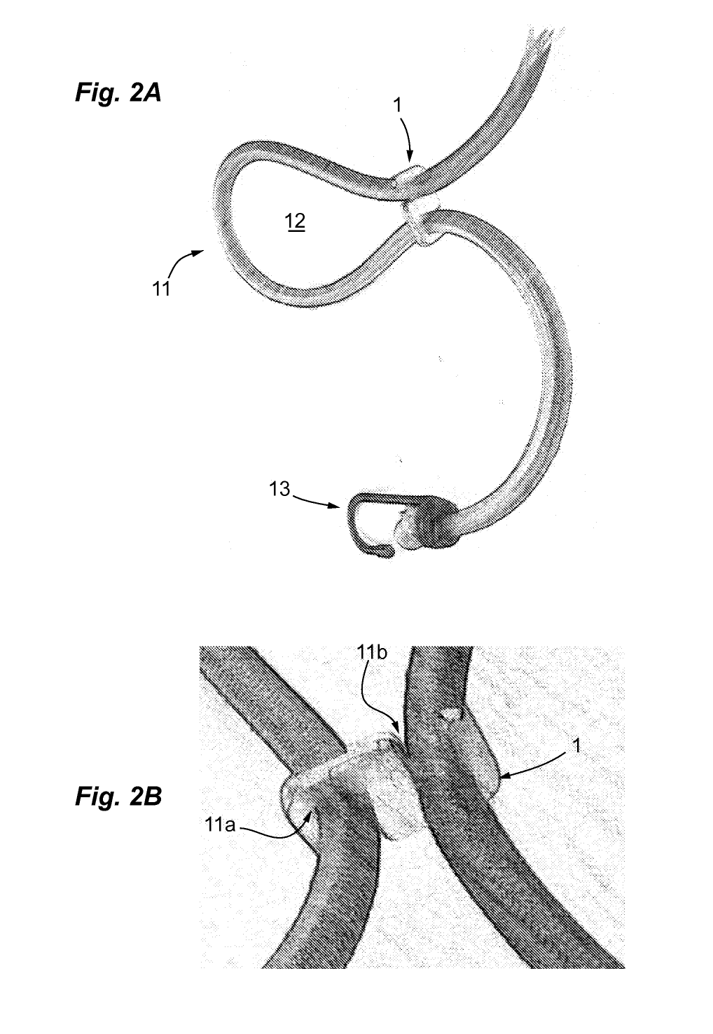

The wording, “sliplessly grip” refers to the capacity of a loop of cord inserted into a clip, with one end of the loop in each of the two slots of the clip, to resist a load of 25 pounds (11.34 kg) applied to the end of the cord beneath the clip while another end of the clip is rigidly suspended from above. In a functional test, termed here the “loop test”, a first end of a bungee cord is affixed to a rigid beam, a loop is formed in the cord and the ends of the loop are inserted into the test clip; then a weight is applied to a second dangling end of the bungee cord beneath the clip. If the loop slips through the clip under the defined load, the slot size is not the correct size to sliplessly grip the cord. Because the manufacturing specification on safe use is a maximum 50% elongation of the cord under load, a 25 lb load is taken as the limit for PASS/FAIL of a clip. Those clips passing the loop test by resisting the 25 pound load are said to be able to “sliplessly grip” the cord under defined conditions of safe use. For standardization of the test, a 5.5 inch loop length is preferred. More detail is provided in the Examples. A loop of cord in a clip of the invention is shown in FIG. 2A.

“Critical dimension” is taken as synonymous with the diameter for generally round cords and for cords having a more belt-like or rectangular shape, the cross-sectional dimension of least width is the critical dimension as defined here, without regard to any radius thereon. Cords having a generally ovoid shape have a cross-sectional dimension characterized by a lesser axis and a greater axis, where the lesser axis dimension is the critical dimension.

General connection terms including, but not limited to “connected,” “attached,” “conjoined,” “secured,” and “affixed” are not meant to be limiting, such that structures so “associated” may have more than one way of being associated.

Relative terms should be construed as such. For example, the term “front” is meant to be relative to the term “back,” the term “upper” is meant to be relative to the term “lower,” the term “vertical” is meant to be relative to the term “horizontal,” the term “top” is meant to be relative to the term “bottom,” and the term “inside” is meant to be relative to the term “outside,” and so forth. Unless specifically stated otherwise, the terms “first,” “second,” “third,” and “fourth” are meant solely for purposes of designation and not for order or for limitation. Reference to “one embodiment,” “an embodiment,” or an “aspect,” means that a particular feature, structure, step, combination or characteristic described in connection with the embodiment or aspect is included in at least one realization of the present invention. Thus, the appearances of the phrases “in one embodiment” or “in an embodiment” in various places throughout this specification are not necessarily all referring to the same embodiment and may apply to multiple embodiments. Furthermore, particular features, structures, or characteristics of the invention may be combined in any suitable manner in one or more embodiments.

It should be noted that the terms “may,” “can,” and “might” are used to indicate alternatives and features of one or more embodiments of the invention, and only should be construed as a limitation if specifically included in a particular claim. The various components, features, steps, or embodiments described here are all “preferred” whether or not specifically so indicated. Claims not including a specific limitation should not be construed to include that limitation. For example, the term “a” or “an” as used in the claims does not exclude a plurality.

“Conventional” refers to a term or method designating that which is known and commonly understood in the technology to which this invention relates.

Unless the context requires otherwise, throughout the specification and claims that follow, the term “comprise” and variations thereof, such as, “comprises” and “comprising” are to be construed in an open, inclusive sense—as in “including, but not limited to.”

The appended claims are not to be interpreted as including means-plus-function limitations, unless a given claim explicitly evokes means-plus-function construction by using the phrase “means for” followed by a verb in gerund form.

A “method” as disclosed herein refers to one or more steps or actions for achieving the described end. Unless a specific order of steps or actions is required for proper operation of the embodiment, the order and/or use of specific steps and/or actions may be modified without departing from the scope of the present invention.

### DETAILED DESCRIPTION

The claimed invention is directed to a detachable clip for securing or shortening a bungee cord on, around, through or over an article or load in need of securing, bundling, wrapping, and the like. The cord length may also be adjusted for use of the cord as a shock absorber or as a spring member. The clip may also be used to daisy chain and to connect two or more bungee cords as a daisy chain or as a mesh net if needed.

The clip includes a plate-like rigid body member having at least two slots, each slot with an open end for receiving a bungee cord pressed therein and a blind or closed end for seating the bungee cord in a slip-resistant position. In a preferred use of the device, the length of the cord may be adjusted. Other uses are described in the figures and in the supporting text that follows.

Clips are mated with compatible cords according the ratio of the ID of the slot (wall to wall) and the OD (or outside critical dimension if not round) of the cord. By trial and error, we have determined that compatible inside width dimensions of the slot and outside critical dimension of a compatible cord are related by a form factor, explicitly the slot and the cord are sized according to a ratio R defined as:

$$R = \frac{SLOT ID}{CORD OD}$$

where R is in a range of about 0.5 to about 0.7 based on the outside dimension of a relaxed bungee cord and inside dimension of a slot (using metric units or an approximate English unit equivalent). Using the range of ID to OD ratios given above for the slot and cord respectively, slot dimensions for non-standard or metric cords can be calculated. Thus the practice of the invention is enabled for a wider range of cords than shown in these exemplary clips. A slot for a 5/16 inch cord may be calculated so as to be a close approximation of a sliplessly gripping clip. By way of example and not limitation, slot widths in the range of 7/32″± 1/32 inch for about ⅜″ inch cords and in a range of 9/32″± 1/32 inch for about ½ inch cords are generally suitable. Alternatively, a functional test giving a PASS or FAIL results may be used to design slot dimensions; one such test is described in EXAMPLE 1 supplementing this description and is herein termed the “loop test”. In other words, the slot to cord ratio may be expressed numerically, but for purposes of defining the scope of the invention, a functional test may also be used, where slippage under a defined pull stress is graded on a PASS/FAIL basis as a function of inside slot dimension.

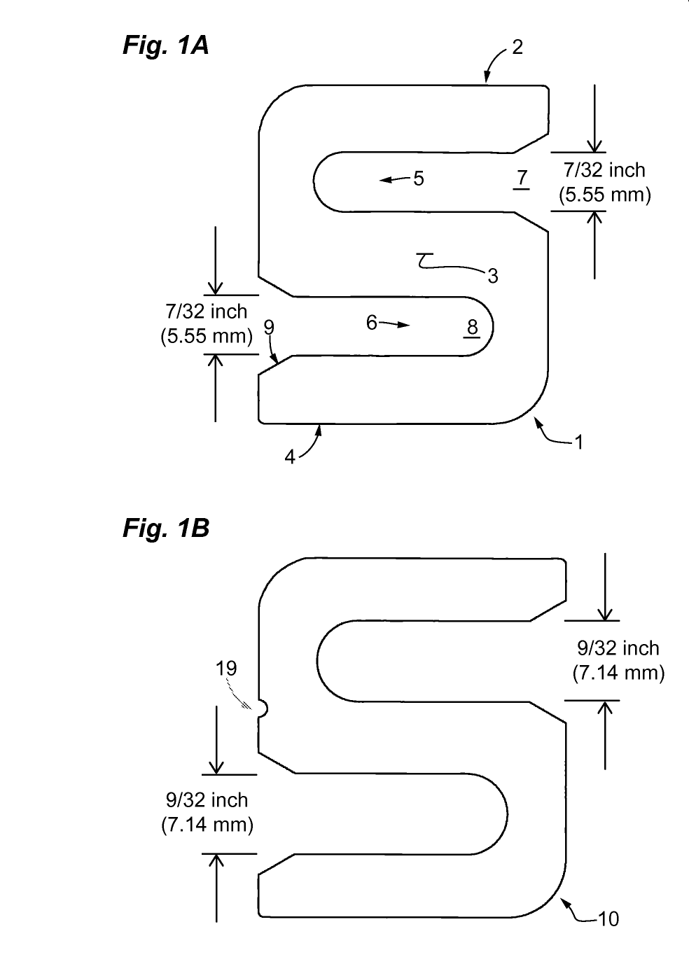

Referring to FIG. 1A, shown is a plan view of a detachable clip 1 having a generally “S” shaped body. The body is generally plate-like, generally having a constant thickness sufficient to be rigid. The “S”-shaped body includes three body sub-segments or arms (2, 3, 4) and two bungee cord-receiving slots (5, 6) defined by the body segments. For convenience, we label the body parts a “first segment arm” (2), a “middle segment” (3) and “a second segment arm” (4), where the first and second segments are disposed on opposite lateral edges of the body. Each receiving slot has an open end 7 and a blind end or pocket 8. In this preferred embodiment, the slots are disposed contralaterally on the body and are parallel but opposite in orientation relative to the ends of the plate body. It is not required, however, that the slots be parallel; slots may be angled if desired to help in “self-seating” as described below and may also be crescent shaped or tapered. FIG. 1B is a view of an “S”-shaped bungee cord clip 10 for a standard half-inch diameter bungee cord. The dimensions disclosed in FIG. 1A are for a bungee cord clip compatible with a standard 9.5 mm cord (about ⅜″ diameter) bungee cord; the slot dimensions disclosed in FIG. 1B are appropriate for a bungee cord having a 12 mm diameter (about a half inch diameter), and are not given as a limitation on the inventive clips but as a demonstration of a sliplessly gripping clip when used as described. For clarity, English units will be used for the remainder of this specification.

In a first preferred embodiment, the clip comprises a body plate, the body plate having two ends and two sides, a thickness, and three rigidly conjoined segments, each segment having two edges, wherein
a) a first lateral segment and a middle segment define a first slot therebetween, the slot having an open end, a blind end, and an inside width dimension configured to sliplessly grip a compatible cord;
b) wherein the middle segment and a second lateral segment define a second slot therebetween, the slot having an open end, a blind end, and an inside width dimension configured to sliplessly grip a compatible cord; and further,
c) wherein the first segment and the second segment are contralaterally disposed on the body such that the open end of the first slot and the open end of the second slot are oriented toward opposite ends of the body and the slots are generally disposed contralaterally along the sides of the body on opposite edges of the middle segment.

In a second preferred embodiment, the clip is configured with slots having an inside width dimension 7/32″± 1/32 inch for receiving a ⅜ inch cord and an inside width dimension of 9/16″± 1/32^{th} inch for receiving a ½ inch cord. Suitable dimensions of a slot for other cord sizes may be determined to a first approximation by a calculation as described above (keeping in mind that many cords are sized in metric units) or may be tested for compatibility with various cords in the functional test described in the EXAMPLE 1.

The two slots are configured to receive each a bungee cord length and the slot inside width dimension is configured when tested to resist slippage of a bungee cord length through the slot from side to side, but without resisting slippage of the bungee cord in and out of the slot. In a preferred embodiment, the blind ends of the slots are offset on the plate body so that a pulling motion of a bungee cord length in each slot is enabled to rotate or torque the plate body slightly, thereby cooperatively self-seating a bungee cord length in each the blind ends. Thus the blind ends form a pocket for seating the cord and squeeze the cord so that slippage through the pocket is resisted. The blind end or pocket wall is generally radiused to maximize intimate contact with the cord. Each open end of the slot is configured with a radius or bevel at the open end, the radius or bevel to facilitate rapid insertion of a bungee cord into each the slots. Clips may be labelled with a mark or indicium 19 of some sort so as to indicate the size of bungee cord compatible with the clip, although the user will quickly discover that the slots of a clip are either too small or too loose if used with an incompatible cord.

In the presently preferred forms, the slots are oppositely oriented with respect to each other, giving the body configuration the general shape of the letter “S”. We term this shape the “S”-shaped body form. Figuratively, if one slot is oriented as a “u”, then the other slot is oriented as an “n”. Each slot is configured with a radius 9 or bevel at said open end, said radius or bevel to facilitate rapid insertion of a bungee cord into each said slots.

The detachable clip of the figures is made preferably out of aluminum and formed by using a punch press, where the die for the press cuts the clip of the invention to a body size of about 1.5 inch long×1 inch high. The slots as shown here are cut with a depth of ¾″ end-to-end. However, the materials, shapes, sizes and process of manufacturing not limiting except as described above for the slot “wall-to-wall” inside dimension. Bodies of fiber-reinforced plastic may also be considered, although safety is a paramount consideration in selecting a rigid body material not subject to slippage due to bending or fatigue. Bodies made of steel (or an alloy or a metal generally) are suitable and may be preferred if higher strength is desired, for example. Aluminum and its alloys are chosen for their lighter weight and may be punch cut, laser cut or extruded to form the slots, for example. Typically metal clips are deburred after shaping, such as by tumbling in a medium. Laser cut edges tend to be sharp, punch cut edges tend to have rough and raised edges, and cut sections from extruded stock are also sharp, so a “deburring” step is useful. Alternatively, clips may be dipped or coated for ease of handling, but care must be taken such that the edge borders of the slot are not so rounded that the cord more readily slips through.

The slots may be parallel as shown in FIGS. 1A and 1B, or may be arcuate, tapered or diverging, for example as described below.

FIG. 2A is a view of a clip 1 of the invention and a bungee cord 11 where the clip is used to form a loop 12 in the cord, thereby adjusting the bungee's length. Advantageously, no loose ends are generated by this process; each end terminates in a hooklet 13. The process of “clipping” the slotted body onto the bungee cord at two positions or segments (11a, 11b) is shown in more detail in FIG. 2B. The cord is inserted and pressed into each slot and then slid to the blind end to maximize slip resistance.

After the user inserts a first position 11a of the cord into a first receiving slot, the user loops the cord to take up any slack in the length, and then inserts a second position 11b of the cord into the second receiving slot so that the overall length of the cord separating its two ends is effectively shortened and the excess length is looped 12. Because the slots are designed so that the loop will not shorten, the user may then secure, wrap, or bundle an article or a load with a cord that has been adjusted to be of an optimal length. End hooklets 13 are used to make connections to secure the load.

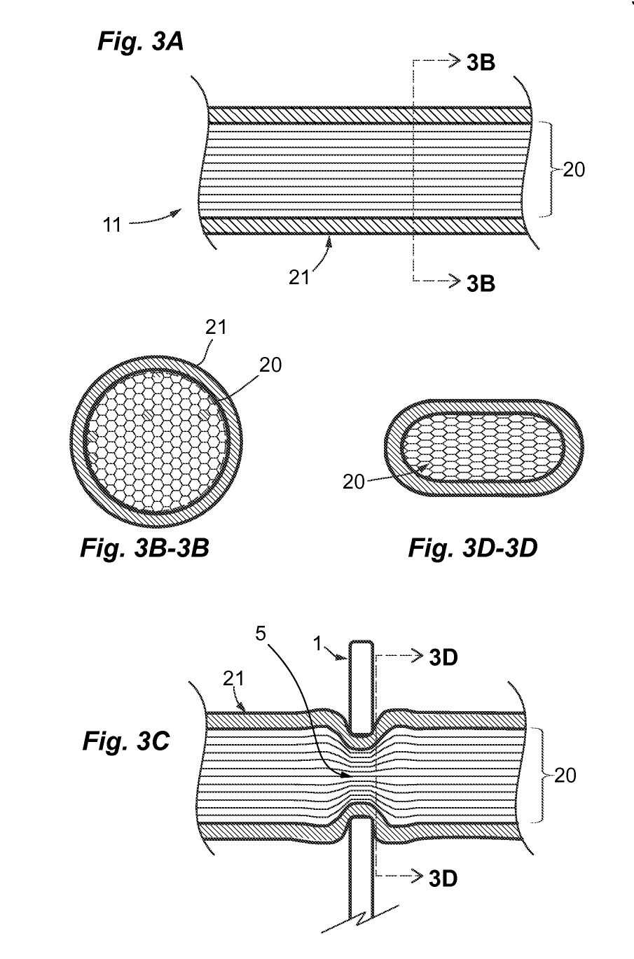

FIGS. 3A and 3C are views of a length of a bungee cord 11 in section with and without a clip. FIGS. 3B-3B and FIG. 3D-3D show cross-sections of the elastomeric core structure 20 and sheath 21 to demonstrate the before and after appearance of the core material under the “squeezing” or “pinching” action of the slot walls when inserted therein. The clip 1 is shown here in an elevation view so that two body member segments separated by a slot 5 are visible edgewise. Because the elastomeric material is squeezed, a donut-shaped bulge of material is displaced onto each side of the slot. Under a pull force, the displaced material becomes a raised ridge and cannot slip through the constricted width dimension of the slot, securing the cord's position under load as much as any knot would. The tension of the cord is carried by the sheath, but the core material expands the sheath perimeter and behaves as a “knot” without the need to tie and untie the knot. When the cord is slipped out of the slot, it reverts to its relaxed shape. As the bungee cord is stretched under load, the core of the cord bundles up against the walls of the slot, strengthening the resistance to slippage of the cord through the slot. Advantageously, the resistance is high with respect to slippage through the slot, but low with respect to slippage along the slot. Under load, the slots are oriented in a generally transverse direction to the pull force vector, eliminating the need to thread the cord through a hole.

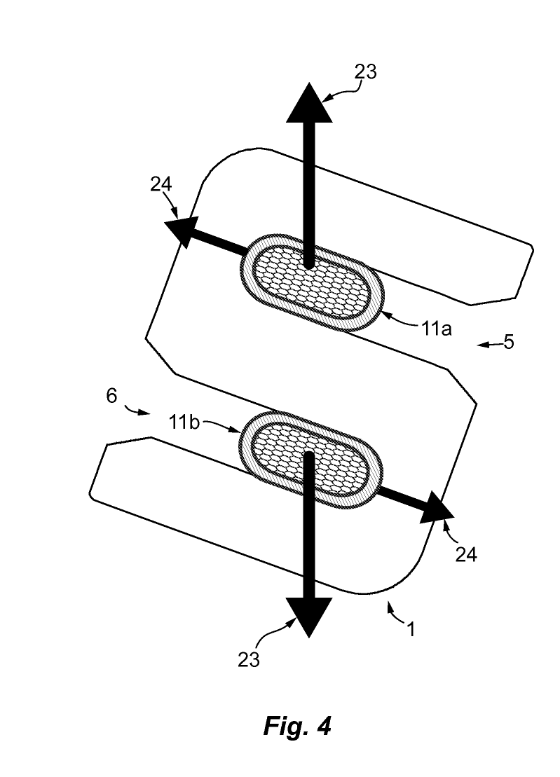

FIG. 4 is a view of an “S”-shaped clip 1 that is “self-seated” under tension on a bungee cord, where here the cord member is represented by cross-sections at positions 11a, 11b drawn into the slots (5, 6) of the clip. Note also the rotation of the body relative to the pull force 23. The loop formed in the cord is in a generally relaxed conformation except at the slot, where tension of the outside strands of the cord tightens and deforms the subjacent and superjacent cord core, building up a ridge having a thickness that cannot slide through the slot.

Arrows indicate force vectors. In the “S”-shaped body, the blind ends of the slots are offset on the plate body so that a pulling motion of a bungee cord length in each slot causes an offset force vector 24 and a minor pivoting motion of the plate that aids in cooperatively self-seating a bungee cord length in the blind end pockets of the slot. The slots are configured with a radius or bevel at the open end, the radius or bevel to facilitate rapid insertion of a bungee cord into each the slots. Engagement and disengagement of the clips on the cords is quick and simple and involves no damage to the cord. The length of cords may adjusted without customization of the endpieces (here typical hooklets as known in the art). A modified endpiece adds expense and is not an option for a cord that lacks them. Thus an unexpected advantage of the inventive clips is their universality and simplicity.

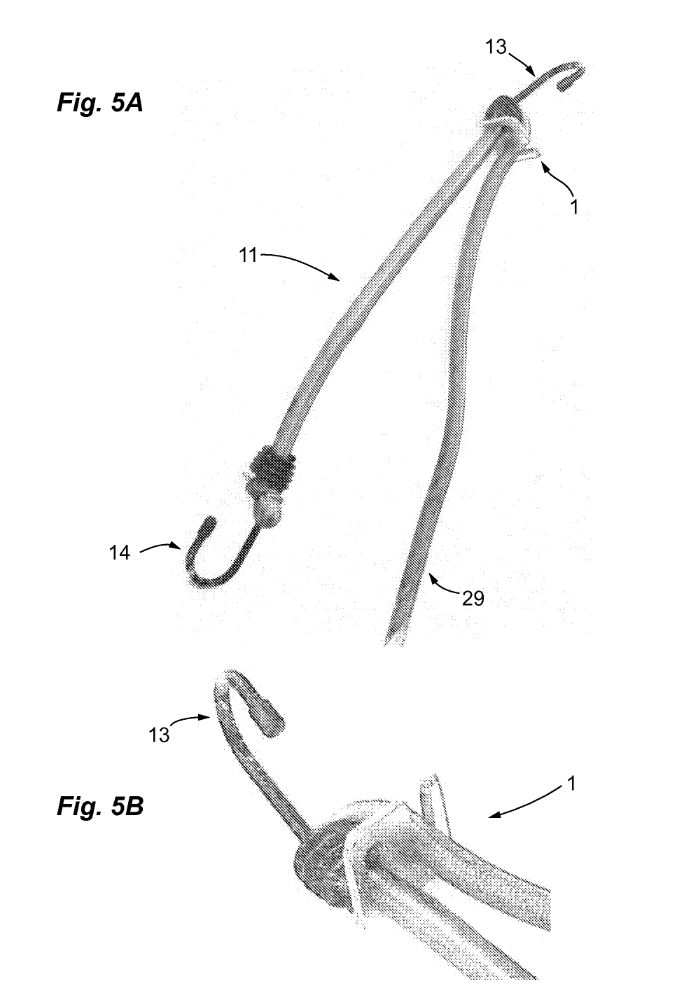

FIGS. 5A and 5B demonstrate another way a detachable clip 1 can be used on a bungee cord 11. A first slot is placed at a desired position on the bungee cord. Then the hooklet 13 of a first end of the bungee cord is slid along the cord and is snugged against the clip. The free end of the bungee cord is bent over into a tight reverse turn or loop and is pressed into a second slot, while securing the hooklet in the loop above the clip. Alternatively the hooklet 13 may be slid into the desired position and the cord folded back over the base of the hooklet. The folded lengths of the cord are then secured against each other with a clip by inserting each cord into a slot. This is shown in more detail in FIG. 5B.

A loose end 29 is generated by this method and may be secured by another clip to another bungee cord if desired, allowing the cords to form a “network” or “mesh” such as is useful for example when securing a tarpaulin over a piece of furniture. Surprisingly, by dimensioning the depth of the slot to accommodate two (or three) sections of cord, the second slot remains open and available for use with a second (and third) bungee cord. Those skilled in the art will realize that complex elastic meshes can be formed. A cord that is captured in a slot will not slide through the slot, so the hooklets need not be placed equidistant from the clip, another advantage in finding flexible uses for the versatile clips of the invention.

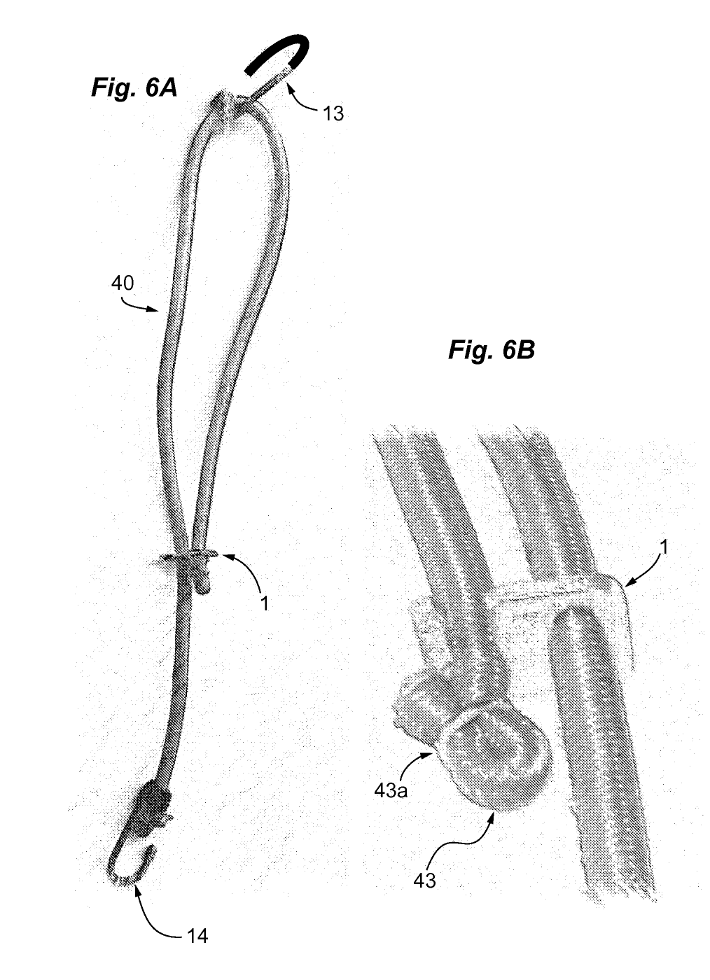

FIGS. 6A and 6B are views of another way a detachable clip 1 can be used on a bungee cord. The first slot of a clip of the invention clamped onto an intermediate position of a bungee cord and then another length of the bungee cord is inserted into the second slot of the clip, thereby creating a double-stranded loop 40 in the cord which results in shortening the bungee to the desired length and supporting hooklet 13 in the loop. The second end includes hooklet 14, enabling the cord to be stretched between two terminal hooklets. In this way, part of the cord length is doubled up, leaving no loose ends or protruding loops. If desired, the loop may be formed to enclose a post, nail, beam, rail, or any heavy object so as to anchor the bungee cord to the object, giving the user more than one way to position the bungee cord(s) depending on the need.

In FIG. 6B, a detail of the clipping action is shown. In this instance an intermediate section of the cord is clipped to an end. The knot 43 formed by the wire staple 43a is typical of conventional bungee cords and ensures that the hooklet stays on the cord when stretched. The knot is not needed for the action of the clip 1 of the invention.

Under stretch load, the body of the clip is torqued by the opposing forces on the ends of the cord. While not shown in FIG. 6B, under torque, the clip will twist so that the slots are pulled in opposite directions by the force. We have observed that the clips are more resistant to slippage in this condition such that even larger slots will sliplessly grip a smaller cord. Thus the functional test disclosed in Example 1 is specific for the loop configuration of FIG. 2A.

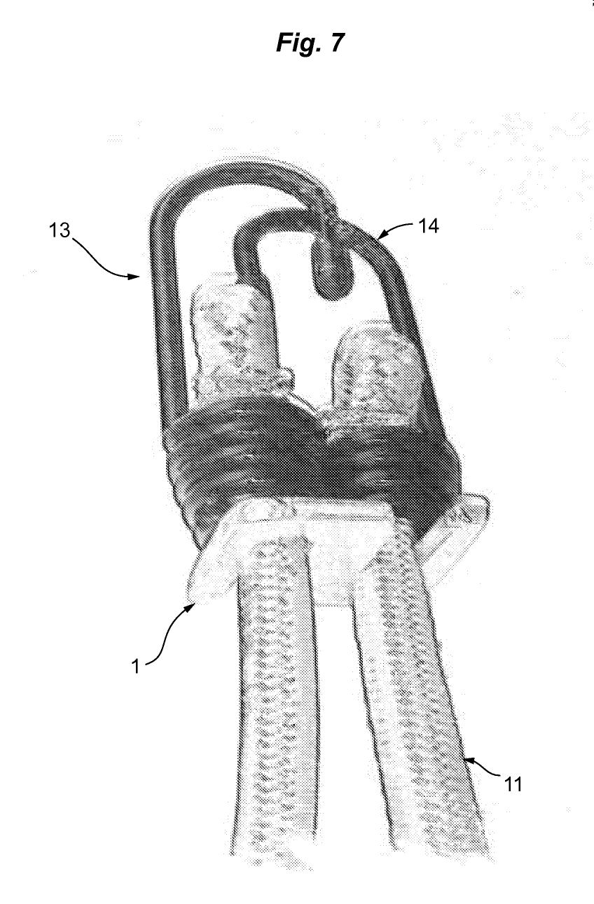

FIG. 7 shows two hooklets (13, 14) of a bungee cord 11 secured side-by-side in a clip 1. Thus the clips also aid in organizing and storing bungee cords such as on hooks on the wall of a garage or in a toolbox. In this position the bungee cord is in a neat looped position for storage as well as limiting the tendency of the cords to become tangled with each other or catching on other items when stored in a bin or a toolbox. Each spare cord is stored with a clip ready for use.

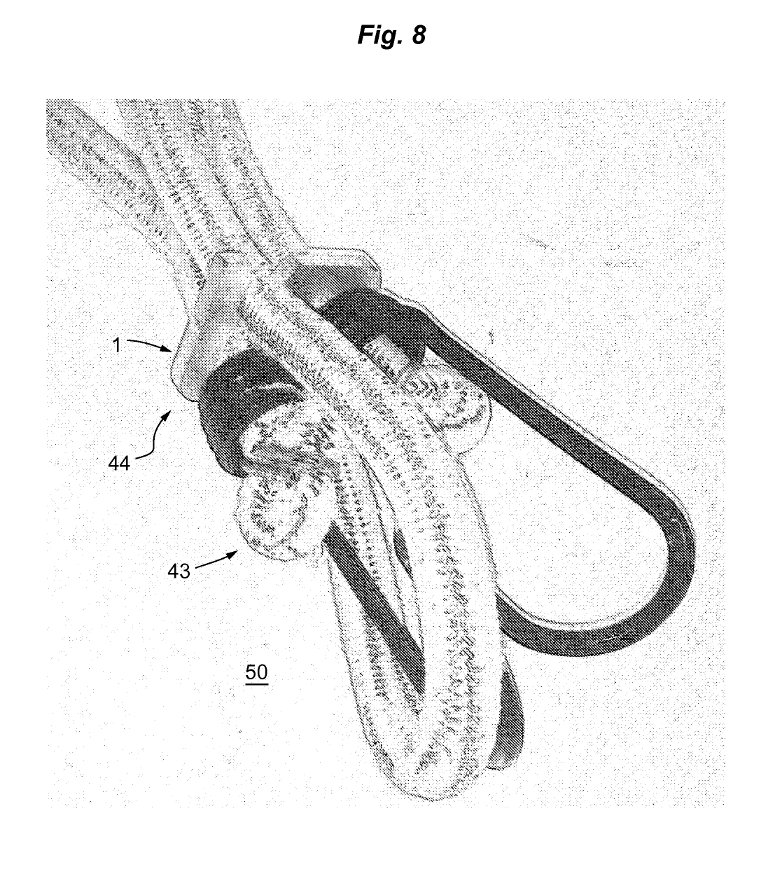

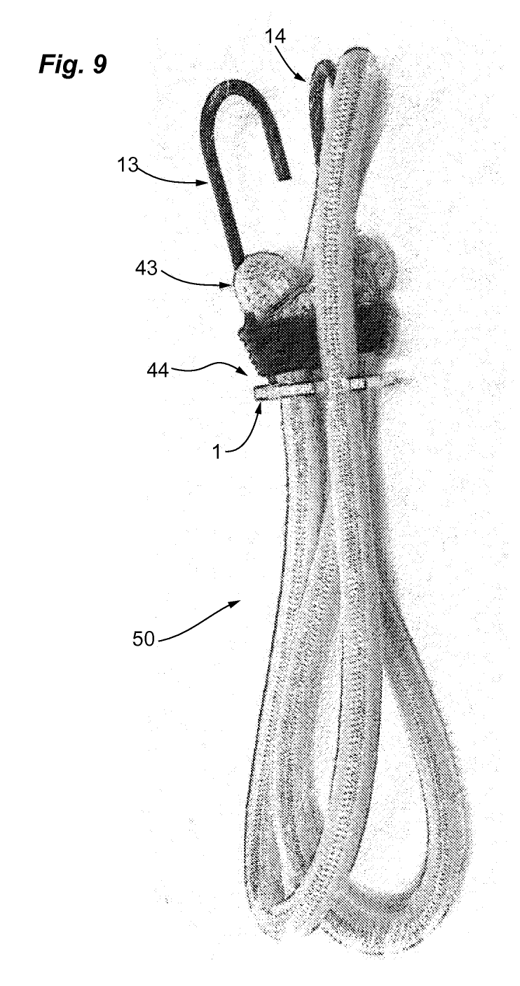

FIGS. 8 and 9 are two views of a bungee cord as bundled for storage. Each section of cord is double-looped 50 and held in the clip at four points 44, as is useful when storing spare cords and clips. Advantageously, each spare cord is neatly bundled by this method and can be stored in a glove box or on a shelf without loss of the clip.

More generally, the invention may also be described as a method in which the object is to maximize the versatility and flexibility of bungee cords for use in securing, wrapping, bundling and tying down loads, objects, tarpaulins and the like. The improved method for securing an article or a load with a bungee cord, comprises steps for a) selecting a first bungee cord having a defined thickness in a critical dimension; b) providing a clip having a body plate, the body plate having three rigidly conjoined segments termed here a first lateral segment, a middle segment, and a second lateral segment, where the first and middle segments define a first slot and the second and middle segments define a second slot; c) inserting a first position of a bungee cord in the first slot; d) inserting a second position of a bungee cord in the second slot so as to adjust the length of the bungee clamp in making a secure fit on the article or load (thereby forming a loop); and, e) stretchingly fitting the bungee cord over the article or load. The loop is configured before securing the load to take up any slack in a bungee cord length while retaining two ends having each a hooklet.

The method may also comprise steps for:
a) forming an inside loop in the bungee cord to take up any slack by inserting two positions of the bungee cord into the clip; or,
b) looping a bungee cord and inserting two ends of the bungee cord into the clip; or,
c) looping a bungee cord and sliding a hook in the bungee cord into the loop by inserting one end position and one intermediate position of the bungee cord into the clip whereby the hook is in the loop and any slack is taken up when stretched; or,
d) double-looping a bungee cord and inserting two ends and two intermediate positions of the bungee cord into the clip, thereby bundling the cord for storage; or,
e) clipping a first bungee cord into a first slot and a second bungee cord into a second slot of the clip, then stretchingly securing all four free ends over the article or load; or,
f) wrapping a loop of a bungee cord around an article or load, and securing the loop snugly against an article or load by joining two positions of the cord at the base of the loop with the clip; or,
g) daisy chaining a pair of like or unlike bungee cords by clipping at least one position of each into the clip,
or a combination of the above.
The improved method may also include combining a plurality of the clips and a plurality of the bungee cords according to any of the clipping methods defined above, such as to make a net or a web therefrom.

As supplied, the body plate has two ends and two sides, a thickness, a width and a length, and three body segments: a first lateral segment, a middle segment, and a second lateral segment, each segment having two edges. A first wall or edge of a first segment and a first wall or edge of a middle segment define a first slot therebetween, the slot having an open end, a blind end, and an inside width dimension that is configured to sliplessly grip a bungee cord. A first wall or edge of a second lateral segment and a second edge or wall of the middle segment define a second slot therebetween, the slot having an open end, a blind end, and an inside width dimension that is configured to sliplessly grip a bungee cord; and further, wherein the first segment and the second segment are contralaterally disposed on the body such that the open end of the first slot and the open end of the second slot are oriented at either end of the body in a body form generally having a S”, “Z”, “E”, “C shape as defined by the body segments and the slots.

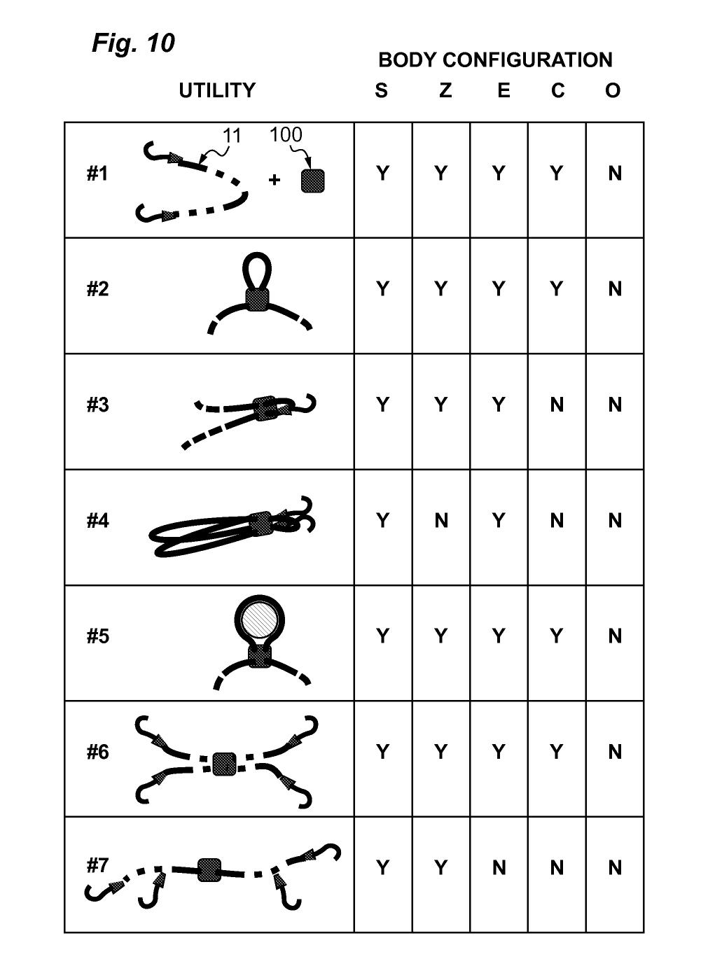

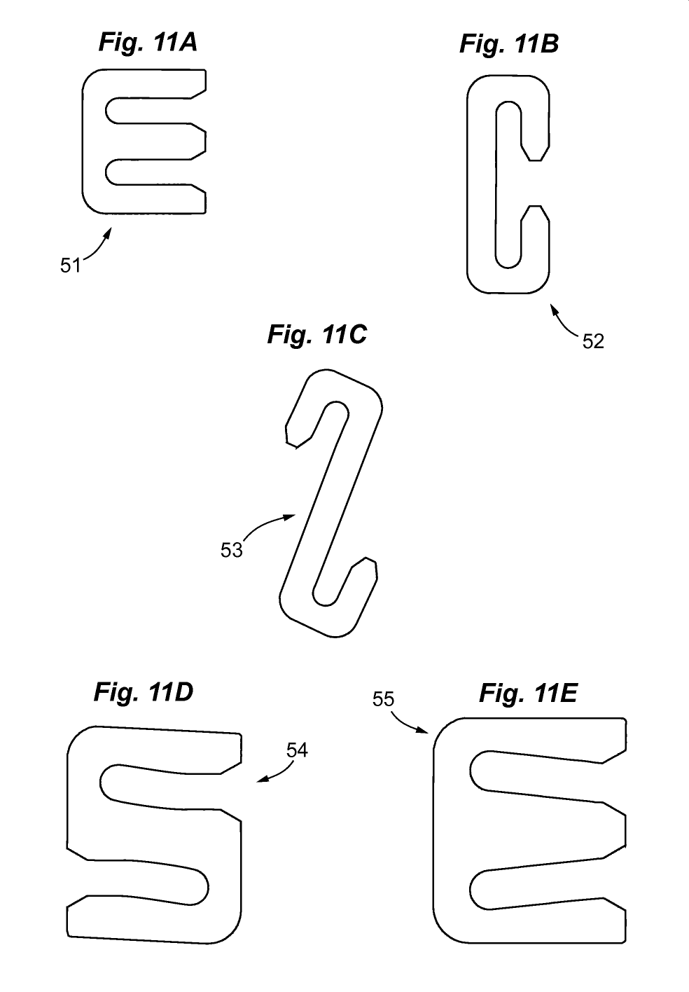

FIG. 10 demonstrates how different configurations of body shapes result in fewer or more uses for bungee cords. Seven configurations are tabulated for five body shapes, including “S”, “Z”, “E”, “C” and “O”. Functionalities are numbered #1, #2, #3, #4, #5, #6 and #7 as shown. Sample forms depicting alternate preferred body types are described in FIGS. 11A-11E, but the invention is not limited thereto. The bungee cord is depicted as a linear or curvilinear form 11 and the generic clip 100 is depicted as a body square with a black fill representing any clip of the invention. Each column on the right represents a distinct body shape, but in each case the clip is shown to be detachable from the cord. Hooklets may not be shown for simplicity of representation but are generally present in some form or another in commercially available bungee cords.

As shown in the table, the “S”-shaped body has a full range of functionality. The “E”- and “C”-shaped bodies are not as versatile because of limitations inherent in the way the slot geometry interacts with force vectors when the cords are stretched under load. Any rotation of the “E”-shaped body may result in slippage of one end of a cord out the side of a slot. The “O” body shape is listed for comparison and has very limited or no functionality because it cannot be attached and detached at will from a cord—and hence fails to meet the first test of versatility (see #1). Versatility tests include #1 (detachability/repositionability); #2 (internal loop formation), #3 (hooklet anchor loop), #4 (double-looping with no free ends), #5 (looping around an object); #6 (pairing); #7 (endwise-pairing with end-hooklets and intermediate hooklets). Based on these basic functions, one skilled in the art will recognize that more complex combinations of elastic members having a plurality of clips and adjustable cord lengths may be formed. The “Z”-shaped body is less compact than the “S”-shape and (as shown) lacks the depth of slots to support inserting two lengths of the cord into each slot. However, it would be within ordinary skill in the art to make deeper slots in a parallelogram “Z”-body form without simply converting it to a more rectangular “S”-shape. Trapezoidal body forms also may be useful, such as where one slot is deeper than the other.

Slightly modifying the body plate and slot shapes so that the outer segment arms may extend and wrap part way around the main body of a clip of the invention so as to create an “entry channel” for the cord may also be considered as well as slots that are angled or curved or of varying width. The depth of the slot is also a factor in determining the range of functionality, where slots having a depth sufficient to accommodate a pair of cords are preferred according to the invention as currently practiced.

FIG. 11A illustrates a plan view of an “E”-shaped bungee cord clip (51).

FIG. 11B is a plan view of a “C”-shaped clip (52).

FIG. 11C is a plan view of a “Z”-shaped clip (53).

FIG. 11D depicts a clip having arcuate slots in a generally “S”-shaped body (54). By adding curvature to the slots, increased stability is obtained comparable to the “Z”-shaped clip, but is more compact.

FIG. 11E depicts a clip having divergent slots in a generally “E”-shaped body (55).

Arcuate slots improve the performance of the clips. Similarly, divergent slots as shown in FIG. 11E improve the performance of the “E”-shaped body, which was not as good as the “S”-shaped body in preventing slippage under normal use.

Generally all the depicted body forms may also be characterized by a slot width, where the slot internal width between the opposing walls or edges of the slot is dimensioned to hold and grip a bungee cord of a particular critical diameter or dimension. The radius at the blind pocket is assumed to be a half-circle but may be modified to an extent without affecting function because of the rubbery compliance of the cord core.

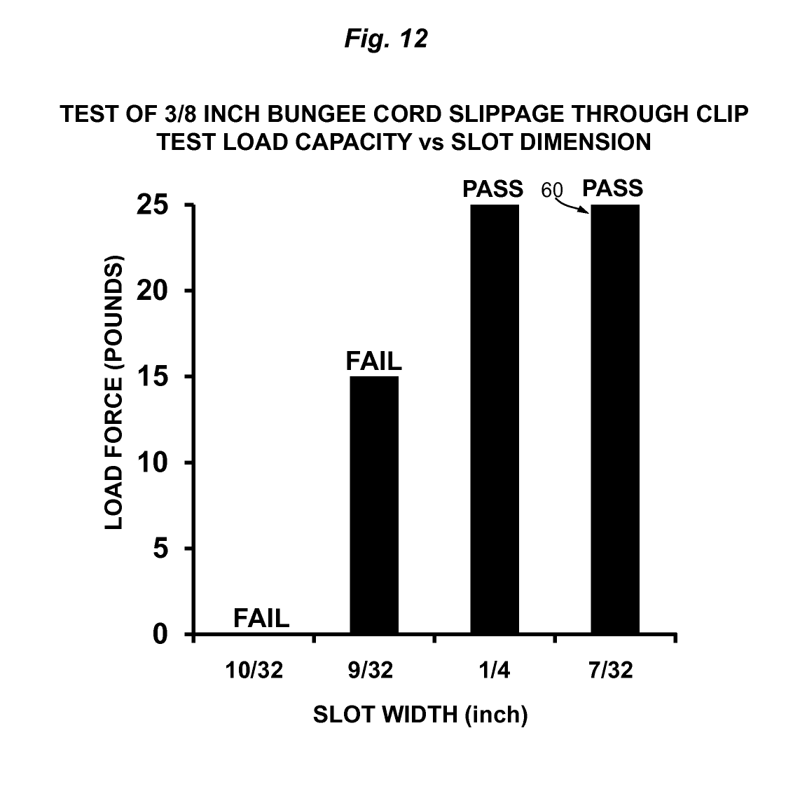

FIG. 12 describes data taken using the functional test described in the Example below. Briefly, a critical slot width is found above which the cords fail to hold. Surprisingly, for the cord diameters shown, only a 32^{nd} of an inch separates a slot width that holds from a slot width that slips on the standard ⅜^{th} inch cord. Slots that are too narrow are likely to damage the cord with repeated use. A preferred slot width of 7/32″ is shown to PASS (60) with a margin of safety.

### Example 1

A functional test was devised, herein termed the “loop test”. A standard bungee cord was anchored at a first end to a beam so that the lower end was free hanging. Two marks were made in the cord such that the marks were separated by 5.5 inches. A bungee clip having two slots was inserted at the marks so as to form a loop about 5.5 inches long (see FIG. 2A for an illustration of a loop 12). Then weights were added incrementally to the free end until the loop slipped through the clip at the lower slot or until a 25 pound load was reached. The weights consisted of small weights weighing 2 or 5 lbs each and were hung in a sling from the lower hooklet. The 25 pound load was considered maximum because this amount of weight stretches the cord more than 50% in length, a condition not to be exceeded according to the manufacturers, and represents a maximum safe use condition.

The following results were obtained with a standard ⅜″ inch bungee cord:
7/32″ paired slots—PASS: no slippage at 15, 20 or 25 pounds
¼″ paired slots—PASS: no slippage at 15, 20 or 25 pounds
9/32″ paired slots—FAIL: no slippage at 15 pounds, but loop slips through at 20 and 25 pounds.

All tests were performed with the slots configured in an “S”-shaped body. When the test was repeated with an “E”-shaped body and a slot width of 7/32″, only 22 pounds of load was supported. These results are plotted in FIG. 12.

When tested with a ½ inch bungee cord:
9/32″ paired slots—PASS: no slippage at 15, 20 or 25 pounds
10/32″ paired slots—PASS: no slippage at 15, 20 or 25 pounds
11/32″ paired slots—FAIL: no slippage at 15 or 20 pounds, but slippage at 25 pounds.

Thus a functional test is sufficient to differentiate slot widths that PASS versus slot widths that FAIL over a requisite range of loads. The results of the test are specific for particular dimensions of bungee cords. Thus a ⅜ inch bungee cord is compatible with a ¼″ or a 7/32 inch slot and a ½ inch bungee cord is compatible with a 10/32″ or a 9/32 inch slot as measured at the inside dimension of the slot. Not all bungee cords are diametrically circular in cross-section; some are more belt-like. The test may be adjusted simply by establishing a critical dimension to be inserted into the slot, where the critical dimension is typically the lesser of the diameter or the least thickness.

### Example 2

For a 5/16ths inch cord, a 7/32 inch slot was found to pass the function test of Example 1. The ratio of the slit inside width dimension to the cord diameter is about 0.69, within the range of R described above. Thus the invention teaches ways to predict a suitable slot size for a given cord critical dimension and may be confirmed by the loop test, for example.

It would be obvious to one skilled in the art, that a “too tight” slot would be unacceptable and could cut, crush, or weaken the cord. A “snug fit” but not a “crushing fit” is desirable. Therefore, a lower limit on slot size is defined here, but is not more than about 1/16^{th} inch smaller than the slot size selected on the basis of the functional test, and most preferably not more than 1/32″ smaller.

### INCORPORATION BY REFERENCE

All of the U.S. patents, U.S. patent application publications, U.S. patent applications, foreign patents, foreign patent applications and non-patent publications referred to in this specification and related filings are incorporated herein by reference in their entirety for all purposes.

### SCOPE OF THE CLAIMS

The disclosure set forth herein of certain exemplary embodiments, including all text, drawings, annotations, and graphs, is sufficient to enable one of ordinary skill in the art to practice the invention. Various alternatives, modifications and equivalents are possible, as will readily occur to those skilled in the art in practice of the invention. The inventions, examples, and embodiments described herein are not limited to particularly exemplified materials, methods, and/or structures and various changes may be made in the size, shape, type, number and arrangement of parts described herein. All embodiments, alternatives, modifications and equivalents may be combined to provide further embodiments of the present invention without departing from the true spirit and scope of the invention.

In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited in haec verba by the disclosure.

### REFERENCE NUMBERS OF THE DRAWINGS

1 “S”-shaped clip
2 First lateral body segment or arm
3 Middle body segment or arm
4 Second lateral body segment or arm
5 First slot
6 Second slot
7 Open end of slot
8 Closed end or pocket of slot
9 Radius or bevel
10 “S” shaped clip for larger bungee cord
11 bungee cord length
11a First inserted position or segment of a bungee cord length
11b Second inserted position or segment of a bungee cord length
12 Intermediate or center loop
13 First end hooklet
14 Second end hooklet
19 Identifying indicum
20 Cord core
21 Cord sheath
23 Pull force vector
24 Lateral offset force vector
29 Free end
40 End loop
43 End knot with wire staple 43a
44 2×2 cord insertion into clip
50 Double folded quad storage bundle
51 “E”-shaped body
52 “C”-shaped body
53 “Z”-shaped body
54 “S”-shaped body with arcuate slots
55 “E”-shaped body with divergent slots
60 “PASS” result
100 Generic clip of the invention (black fill)

We claim:

1. A detachable clip for interchangeable uses with one or more bungee cords, said clip comprising
(a) a body plate, the body plate having two ends and two sides, a thickness, and three rigidly conjoined segments, each segment having two edges;
(b) wherein a first lateral segment and a middle segment define a first slot therebetween, the slot having an open end, a blind end, and an inside width dimension configured to sliplessly grip a compatible cord when inserted therein;
(c) wherein the middle segment and a second lateral segment define a second slot therebetween, the slot having an open end, a blind end pocket, and an inside width dimension configured to sliplessly grip a compatible cord when inserted thereon; and,
(d) wherein the first segment and the second segment are contralaterally disposed on the body such that the open end of the first slot and the open end of the second slot are oriented toward opposite ends of the body and the slots are generally disposed contralaterally along the sides of the body on opposite edges of the middle segment, thereby forming a generally “S”-shaped body.

2. The clip of claim 1, wherein said slots are configured to receive each a bungee cord length and said slot inside width dimension is configured to resist slippage of a bungee cord length endwise along a cord without resisting slippage of a bungee cord sideways in and out of said slot.

3. The clip of claim 2, wherein said blind end pockets of said slots are offset on said plate body so that a pulling motion of a bungee cord length in each slot is enabled to pivot the plate body, thereby cooperatively self-seating a bungee cord in each said blind end pockets when inserted therein and stretched.

4. The clip of claim 1, wherein each said slot is configured with a radius or bevel at said open end, said radius or bevel to facilitate rapid insertion of a bungee cord into each said slots.

5. A detachable clip for use with one or more bungee cords having a defined thickness in at least transverse one dimension, which comprises:
(a) a body plate; said body plate having two ends and two sides, a thickness, and three rigidly conjoined segment arms, each segment arms having two edges, a width and a length;
(b) wherein a first lateral segment and a middle segment define a first slot therebetween, said slot having an open end, a blind end pocket, and an inside width dimension that is fractionally 0.5 to 0.7 of a defined thickness of a bungee cord;
(c) wherein said middle segment and a second lateral segment define a second slot therebetween, said slot having an open end, a blind end pocket, and an inside width dimension that is fractionally 0.5 to 0.7 of a defined thickness of a bungee cord; and further,
(d) wherein said first segment and said second segment are contralaterally disposed on said body such that said open end of said first slot and said open end of said second slot are oriented toward opposite ends of said body and said slots are generally disposed on opposite edges of said middle segment.

6. The clip of claim 5, wherein said slots are configured to receive each a bungee cord segment and said slot inside width dimension is configured to resist slippage of a bungee cord length endwise along a cord without resisting slippage of a bungee cord sideways in and out of said slot.

7. The clip of claim 5, wherein said blind end pockets of said slots are offset on said plate body so that a pulling motion of a bungee cord length in each slot is enabled to pivot the plate body, thereby cooperatively self-seating a bungee cord in each said blind end pockets when inserted therein and stretched.

8. The clip of claim 5, wherein each said slot is configured with a radius or bevel at said open end, said radius or bevel to facilitate rapid insertion of a bungee cord segment into each said slots.

9. The clip of claim 5, further comprising an indicum or markings identifiably labelling said clip for use with at least one size of bungee cord.

10. An improved method for securing an article or a load with a bungee cord, which comprises:
a) selecting a first bungee cord having a defined thickness in at least one transverse dimension;
b) providing a clip having a body plate, said body plate having two ends and two sides, a thickness, three rigidly conjoined segments, each segment having two edges, a width and a length, wherein a first lateral segment and a middle segment define a first slot therebetween, said slot having an open end, a blind end, and an inside width dimension configured to sliplessly grip a bungee cord, wherein said middle segment and a second lateral segment define a second slot therebetween, said slot having an open end, a blind end, and an inside width dimension configured to sliplessly grip bungee cord; and further wherein said first segment and said second segment are contralaterally disposed on said body such that said open end of said first slot and said open end of said second slot are oriented toward opposite sides of said body and said slots are disposed on opposite edges of said middle segment;
c) inserting a first position of said bungee cord into said first slot;
d) inserting a second position of a bungee cord into said second slot so as to take up any slack in a bungee cord length; and,
e) stretchingly fitting said bungee cord over said article or load.

11. The improved method of claim 10, which comprises a step selected from:
a) forming an inside loop in said bungee cord to take up any slack by inserting two positions of said bungee cord into said clip;
b) looping a bungee cord and inserting two ends of said bungee cord into said clip;
c) looping a bungee cord and sliding a hook in said bungee cord into the loop by inserting one end position and one intermediate position of said bungee cord into said clip whereby said hook is in said loop and any slack is taken up when stretched;
d) double-looping a bungee cord and inserting two ends and two lengths of said bungee cord into said clip, thereby bundling said cord for storage;
e) clipping a first bungee cord into a first slot and a second bungee cord into a second slot of said clip, then stretchingly securing all four free ends over said article or load;
f) wrapping a loop of a bungee cord around an article or load, and securing the loop snugly against an article or load by joining two positions of said cord at the base of said loop with said clip; or,
g) daisy chaining a pair of like or unlike bungee cords by clipping at least one length of each into said clip.

12. The improved method of claim 10, further comprising a step for using a plurality of said clips and a plurality of said bungee cords to make a net or a web.

13. A detachable clip for attaching a bungee cord to itself, which comprises a plate body having outside edges and disposed therein a first slot and a second slot, wherein said slots have an open end, a blind end, a depth, and an inside width dimension configured such that said inside width dimension is fractionally 0.5 to 0.7 of a defined thickness of a bungee cord, further wherein said plate body with first and second slots is configured in a generally “S”-shape as defined by the orientation of said slots, a generally “Z”—as defined by the orientation of the slots, a generally “E” shape as defined by the orientation of said slots, or a generally “C” shape as defined by the orientation of said slots, and not in an “O” shape or an “H” shape.

14. The clip of claim 13, wherein said first slot and said second slot have a depth configured for insertion of two lengths of bungee cord per slot.

15. The clip of claim 13, wherein said slots are generally arcuate or divergent.
